(19) United States
(12) Patent Application Publication
(10) Pub. No.: US 2021/0259458 A1
(43) Pub. Date: Aug. 26, 2021

(54) Delivering Device Of A Liquid Substance For Preparing Beverages

(71) Applicant: Danilo Spagna, Coniolo (IT)

(72) Inventor: Danilo Spagna, Coniolo (IT)

(21) Appl. No.: 17/315,339

(22) Filed: May 9, 2021

Related U.S. Application Data
(63) Continuation of application No. 16/077,481, filed on Aug. 12, 2018, now abandoned.

(30) Foreign Application Priority Data
Feb. 6, 2017 (WO) 2017/141280

(51) Int. Cl. A47J 31/40; A47J 31/41; A47J 31/46

(52) U.S. Cl. CPC A47J 31/402; A47J 31/46; A47J 31/41

(57) ABSTRACT

A delivering device of a liquid substance for preparing beverages is described, comprising at least one nozzle adapted to be placed, in a sequence, next to at least one container of a battery of containers to allow outwards pouring a dose of the liquid substance, in a pre-established amount, such delivering device of a liquid substance for preparing beverages comprising at least one extracting device of vapors of the liquid substance released in a space between the battery of containers and the nozzle.

### CROSS-REFERENCE TO RELATED APPLICATIONS

This application is application is a continuation of U.S. patent application Ser. No. 16/077,481, which is a national stage of International Patent Application No. 2017/141280, titled “Delivering Device Of A Liquid Substance For Preparing Beverages,” filed 6 Feb. 2017, which claims priority from Italian Patent Application No. PCT/IT2017/000021 filed 19 Feb. 2016, the contents of which are incorporated in this disclosure by reference in their entirety.

### FIELD OF THE INVENTION

The present invention refers to a delivering device of a liquid substance for preparing beverages.

In particular, the present invention deals with systems for preparing beverages in which such device is necessary to deliver liquids and to allow mixing such liquids.

### BACKGROUND

Multi-beer apparatuses are known, comprising a plurality of delivering assemblies which are configured to be selectively actuated in a coupled mode, wherein such plurality of delivering assemblies cooperate for quickly producing a higher amount of delivered beverage in a single seat, or in an independent mode in which the plurality of delivering assembles operate independently for producing a fermented beverage delivered in different positions.

The state of the art is given by patents about apparatuses for preparing beverages dealing with mixers for liquids outside a nozzle and cleaning apparatuses for beverage delivering devices.

For example, patent EP2355667B1 refers to an integrated system for delivering beverages comprising a delivering module of one or more ingredients in different containers and a mixer which allows mixing the ingredients in such containers. The delivering module comprises a single delivering nozzle for the plurality of containers. The mixer is connected to a linear slider actuated by a stepped motor through a controller which provides a specific mixing profile for a given beverage.

Patent EP2355667B1, however, does not solve the problem of delivering beverages composed of volatile substances. This problem is instead mentioned in U.S. Pat. No. 7,389,943B2 dealing with an apparatus for delivering a volatile substance and comprising: an electro-mechanical distributor to deliver a volatile substance; a cartridge for keeping a plurality of containing tanks for volatile substances to be delivered; and a rotating arm for alternately disengage a tank from the delivering device and engage a following tank.

U.S. Pat. No. 7,389,943B2 refers in general to systems for treating air through the use of volatile substance. For this purpose, U.S. Pat. No. 7,389,943B2 can be used as starting point to define the present invention.

Another problem present in systems for preparing beverages is given by the lack of a constructive simplification, though keeping high quality requirement in preparing the beverages. This problem is instead mentioned in U.S. Pat. No. 4,391,390A, dealing with devices for mixing and batching chemical substances, completely operated without the use of timed valves or electrically actuated valves, exclusively operating due to pressure differences, obtaining a controlled mixing without the costs and uncertainty of electrically controllable solenoid valves or other timed batching devices.

Documents U.S. Pat. Nos. 5,312,820, 5,927,553 and WO-A1-03/041546 disclose delivering devices according to the preamble of claim 1.

### BRIEF DESCRIPTION OF THE DRAWINGS

the present invention will be better described by some preferred embodiments thereof, provided as a non-limiting example, with reference to the enclosed drawings, in which:

FIGS. 1 and 2 respectively show a perspective view and a top view of a preferred embodiment of the delivering device of a liquid substance for preparing beverages according to the present invention;

FIGS. 3 and 4 respectively show a perspective view and a top view of some components of the delivering device according to the present invention; and

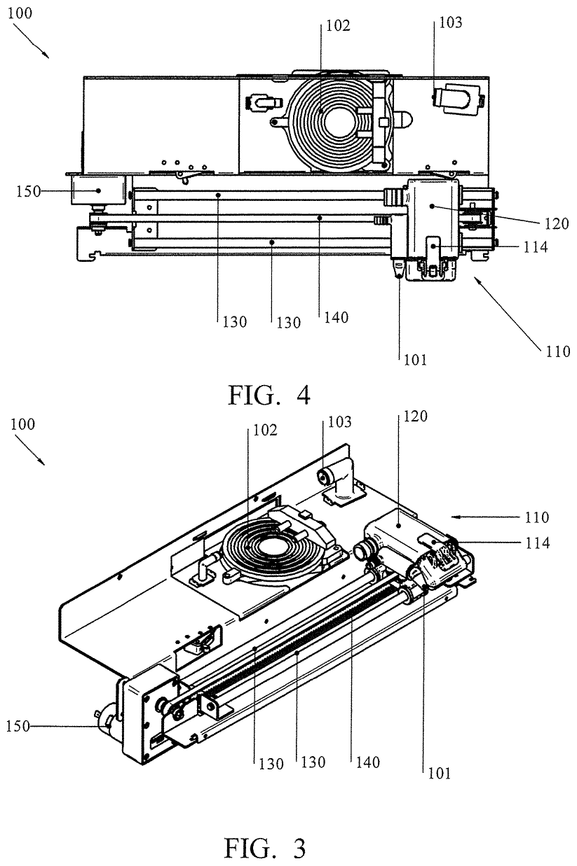

FIGS. 5 and 6 respectively show a perspective view and a top view of the components of FIGS. 3 and 4 partially disassembled.

### SUMMARY

Object of the present invention is solving the above prior art problems, by providing a delivering device which is able to suck vapours to allow mixing such liquids, by increasing the quality of a beverage through a mixing process which is free from volatile substances.

A further object of the present invention is providing a delivering device which allows simplifying the construction and the operating logics of a system for preparing beverages by doing without solenoid valves and timed devices.

The above and other objects and advantages of the invention, as will appear from the following description, are obtained with a device for delivering a liquid substance for preparing beverages as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention as appears from the enclosed claims.

### DETAILED DESCRIPTION OF THE INVENTION

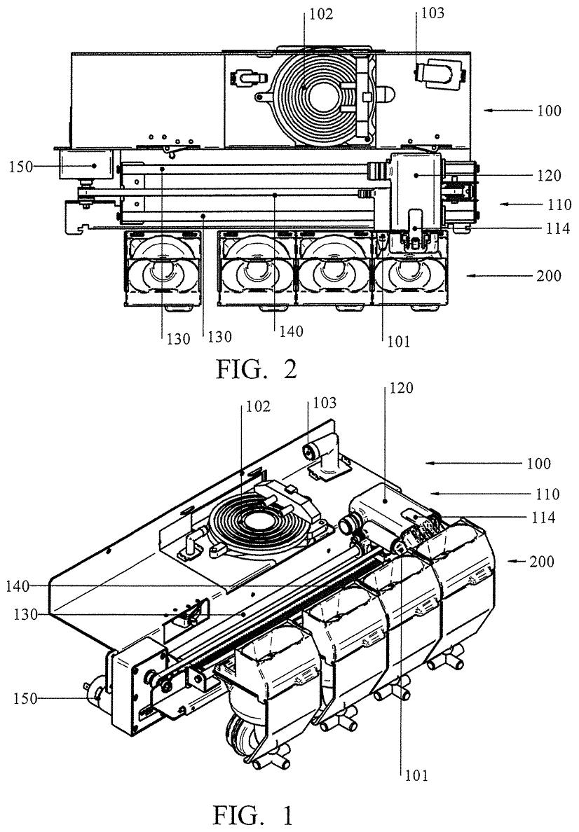

Therefore, with reference to FIGS. 1 and 2, it is possible to note that a delivering device 100 of a liquid substance for preparing beverages according to the present invention comprises at least one nozzle 101 adapted to be placed, in a sequence, next to at least one container of a battery 200 of containers to allow outwards pouring a dose of the liquid substance, in a pre-established amount and mixed with other ingredients of the beverages.

Advantageously, such delivering device 100 of a liquid substance for preparing beverages comprises at least one extracting device 110 of vapours of the liquid substance released in a space between the battery 200 of containers and the nozzle 101.

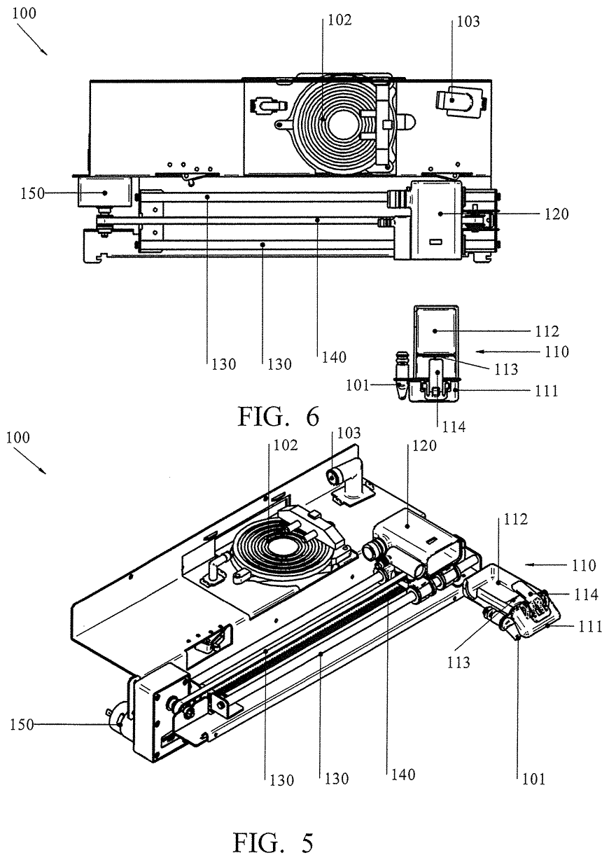

With reference to FIGS. 5 and 6, it is possible to note that the extracting device 110 comprises capturing means 111 and collecting means 112 of vapours of the liquid substance released in a space between the battery 200 of containers and the nozzle 101.

In particular, the delivering device 100 of a liquid substance for preparing beverages comprises at least one trolley 120 sliding along guiding means 130 and dragged with transmission means 140 by at least one controlled motor 150.

The trolley 120 allows transporting the nozzle 101 and the extracting device 110 of vapours of the liquid substance.

The extracting device 110 is separable from the trolley 120 to allow cleaning the collecting means 112.

The nozzle 101 is connected through at least one hydraulic flexible tube (not shown) to thermal-hydraulic means 102 comprising at least one boiler for heating the liquid substance to be sent to the nozzle 101.

According to a variation of the delivering device 100, the thermal-hydraulic means 102 are fixed with respect to the trolley 120 and lacking solenoid valves or timed or intercepting elements of the liquid substance.

The extracting device 110 is connected through a hydraulic flexible tube (not shown) to sucking means 103 comprising at least one fan.

According to a further variation of the delivering device 100, the sucking means 103 are fixed with respect to the trolley 120 and lacking solenoid valves or timed or intercepting elements of the liquid substance.

The capturing means 111 comprise at least one hood opened at the base to allow flowing the vapours of the liquid substance towards the collecting means 112. Moreover, the collecting means 112 comprise at least one tank.

The capturing means 111 and the collecting means 112 are separated by at least one wall 113 open on its top and equipped with closing means 114 adapted to allow blocking with respect to the trolley 120.

The guiding means 130 comprise at least one pair of calibrated rods adapted to slide the trolley 120. The transmission means 140 comprise a toothed belt adapted to connect a pinion free of rotating with respect to the trolley 120, with a pinion integral with the shaft of the controlled motor 150.

The delivering device 100 of a liquid substance for preparing beverages of the present invention allows obtaining its pre-set objects.

In fact, the delivering device 100 of a liquid substance for preparing beverages allows delivering a liquid substance, normally water, in a battery of containers, normally suitable mixers, and simultaneously sucking possible vapours.

The delivering device 100 of a liquid substance for preparing beverages comprises a delivering device of the fluid adapted to linearly move or through another type of movement to be able to reach the delivering points of a mixer, through a trolley sliding.

Moreover, the delivering device 100 of a liquid substance for preparing beverages comprises a water inlet device connected to a nozzle and a tube for sucking the vapour adapted to linearly move or through another type of movement to be able to reach the delivering point of the mixer.

A kinematism allows the delivering device of the fluid, the water inlet delivering device and the tube for sucking vapour to reach the delivering points remaining on board the sliding trolley.

The vapour sucking circuit is an extracting device of vapours of the liquid substance connected through a flexible tube from the fan to the vapour taking device integral with the fluid delivering system.

The hydraulic circuit can be simplified with an exchanger/boiler of heat connected through a flexible tube to the delivering point without using solenoid shunting valves downstream of the exchanger/boiler outlet.

What has been described is a new and improved systems for preparing beverages in which such device is necessary to deliver liquids and to allow mixing such liquids, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A delivering device comprising:
a) at least one nozzle for a liquid substance for preparing beverages, adapted to be placed, in a sequence;
b) at least one container coincident to the at least one nozzle;
c) at least one vapor extracting device connected to the at least one nozzle;
d) at least one trolley connected to the least one nozzle;
e) a guiding means operably connected to the at least one trolley;
f) a transmission means operably connected to the at least one guiding means;
g) at least one controlled motor operably connected to the transmission means; and
h) a sucking means operably connected to the at least one vapor extracting device.

2. The delivering device of claim 5, wherein the at least one nozzle is configured to allow outwards pouring a dose of the liquid substance, in a pre-established amount.

3. The delivering device of claim 5, wherein the at least one vapor extracting device comprises a capturing means and a vapor collecting means.

4. The delivering device of claim 5, wherein the at least one trolley is adapted to transport the at least one nozzle and the at least one vapor extracting device.

5. The delivering device of claim 5, wherein the thermal-hydraulic means comprises at least one boiler for heating the liquid substance to be sent to the at least one nozzle.

6. The delivering device of claim 10, wherein the thermal-hydraulic means is fixed with respect to the trolley.

7. The delivering device of claim 10, wherein the thermal-hydraulic means does not comprise solenoid valves, timed elements, or intercepting elements for the liquid substance.

8. The delivering device of claim 7, wherein the at least one vapor extracting device is connected through at least one tube to the sucking means.

9. The delivering device of claim 5, wherein the at least one sucking means comprises at least one fan, wherein the sucking means is fixed with respect to the trolley.

10. The delivering device of claim 5, wherein the at least one vapor extracting device is separable from the trolley to allow cleaning the collecting means.

11. The delivering device of claim 5, wherein the capturing means comprise at least one hood open at its base to allow the vapors of the liquid substance to flow towards the collecting means.

12. The delivering device of claim 5, wherein the collecting means comprises at least one tank.

13. The delivering device of claim 5, wherein the capturing means and the collecting means are separated by at least one wall open on its top and equipped with a closing means adapted to allow blocking with respect to the trolley.

14. The delivering device of claim 5, wherein the guiding means comprises at least one pair of calibrated rods adapted to slide the trolley.

15. The delivering device of claim 5, wherein the transmission means comprises a toothed belt adapted to connect a pinion free of rotating with respect to the trolley with a pinion integral with the shaft of the at least one controlled motor.
